(19) United States
(12) Patent Application Publication
(10) Pub. No.: US 2024/0278323 A1
(43) Pub. Date: Aug. 22, 2024

(54) Gas atomizer

(71) Applicant: ArcelorMittal, Luxembourg (LU)

(72) Inventor: Benjamin BOISSIERE, Metz (FR)

(21) Appl. No.: 18/571,606

(22) PCT Filed: Jun. 22, 2022
(86) PCT No.: PCT/IB2022/055785

§ 371 Date: Dec. 18, 2023

(30) Foreign Application Priority Data
Jun. 28, 2021 (WO) PCT/IB2021/055756

(51) Int. Cl. B22F 9/08

(52) U.S. Cl. CPC B22F 9/082; B22F 2009/0832; B22F 2009/0876; B22F 2009/0888; B22F 2009/0896; B22F 2998/10

(57) ABSTRACT

A process for manufacturing metal powders including: i) feeding an atomization chamber of a gas atomizer with molten metal, (ii) atomizing the molten metal by injection of gas so as to form metal particles, (iii) transferring the metal particles from the atomization chamber to a cooling chamber of the gas atomizer, (iv) cooling the metal particles in the cooling chamber by injecting gas from the bottom of the cooling chamber so as to form a bubbling fluidized bed of metal particles. A gas atomizer thereof is also provided.

The present invention relates to a gas atomizer for the production of metal powders and in particular for the production of steel powders for additive manufacturing. The present invention also relates to the method for manufacturing metal powders by gas atomization.

### BACKGROUND

There is an increasing demand for metal powders for additive manufacturing and the manufacturing processes have to be adapted consequently.

### SUMMARY OF THE INVENTION

It is notably known to melt metal material and to pour the molten metal in a tundish connected to an atomizer. The molten metal is forced through a nozzle in a chamber under controlled atmosphere and impinged by jets of gas which atomize it into fine metal droplets. The latter solidify into fine particles which fall at the bottom of the chamber and accumulate there until the molten metal has been fully atomized. The powder is then let to cool in the atomizer until it reaches a temperature where it can be in contact with air without oxidizing too quickly. The atomizer is then opened to collect the powder. Such a cooling is a long process which is not compatible with the need for producing large amounts of metal powders.

An aim of the present invention is therefore to remedy the drawbacks of the facilities and processes of the prior art by providing a gas atomizer wherein the obtained powder can be rapidly cooled in the atomizer.

Also, the process according to the prior art described above is a batch process which is not compatible with the need for producing large amounts of metal powders in a continuous mode.

An additional aim of the present invention is to provide a gas atomizer wherein the obtained powder can be discharged from the atomizer without disrupting the atomization.

For this purpose, a first subject of the present invention consists of a process for manufacturing metal powders, comprising:
(i) feeding an atomization chamber of a gas atomizer with molten metal,
(ii) atomizing the molten metal by injection of gas so as to form metal particles,
(iii) transferring the metal particles from the atomization chamber to a cooling chamber of the gas atomizer,
(iv) cooling the metal particles in the cooling chamber by injecting gas from the bottom of the cooling chamber so as to form a bubbling fluidized bed of metal particles.

The process according to the invention may also have the optional features listed below, considered individually or in combination:
the molten metal is steel obtained through a blast furnace route,
the molten metal is steel obtained through an electric arc furnace route,
steps (ii), (iii) and (iv) are done simultaneously,
in step (iv), the metal particles are cooled below 300° C.,
in step (iv), the injected gas is extracted, cooled down and re-injected,
the gas is cooled down below 50° C.,
the process further comprises the step (v) of continuously discharging metal particles from the cooling chamber,
the continuous discharge is done through an overflow,
the process further comprises the step (vi) of transporting the discharged metal particles to a sieving station,
the discharged metal particles are transported in the form of a fluidized bed,
the process further comprises an additional step between steps (ii) and (iii) wherein the metal particles undergo a first cooling step in the atomization chamber by injecting gas from the bottom of the atomization chamber so as to form a bubbling fluidized bed (15) of metal particles,
the cooling steps in the atomization chamber and in the cooling chamber are done with different gases.

A second subject of the invention consists of a gas atomizer comprising an atomization chamber and a cooling chamber connected to the bottom of the atomization chamber, gas injectors positioned at the bottom of the cooling chamber and a flow regulator coupled to the gas injectors for fluidizing the metal particles to be accumulated in the cooling chamber and forming a bubbling fluidized bed of metal particles.

The gas atomizer according to the invention may also have the optional features listed below, considered individually or in combination:
the gas injectors comprise openings in the bottom wall of the cooling chamber,
the distance between the bottom of the cooling chamber and the gas injectors is preferably shorter than 10 cm,
the gas injectors are spargers,
the gas atomizer further comprises a heat exchanger positioned in the lower section of the cooling chamber,
the gas atomizer further comprises an overflow in the lower section of the cooling chamber,
the overflow is a pipe at least partially extending in the lower section of the cooling chamber and passing through the bottom wall of the cooling chamber,
the portion of the overflow outside the cooling chamber comprises a gas inlet,
the gas atomizer further comprises a coarse particles collector at the bottom of the cooling chamber,
the gas atomizer further comprises a gas extractor in the upper section of the cooling chamber,
the gas extractor comprises a cyclone separator for dedusting the gas extracted from the chamber,
the gas extractor is connected to the gas injectors for gas recirculation within the atomizer,
the connection between the gas extractor and the gas injectors comprises a heat exchanger,
the gas atomizer further comprises gas injectors positioned at the bottom of the atomization chamber and a flow regulator coupled to the gas injectors for fluidizing the metal particles to be accumulated in the lower section of the atomization chamber and forming a bubbling fluidized bed of metal particles.

A third subject of the invention consists of an installation comprising a gas atomizer according to the invention and a conveyor comprising a lower duct for the circulation of gas, an upper duct connected to the cooling chamber for the circulation of powder material and a porous wall separating the lower and upper ducts over substantially their entire length.

The installation according to the invention may optionally have the lower duct of the conveyor comprise a fluidization gas inlet and a flow regulator coupled to the fluidization gas inlet for fluidizing the metal particles to be discharged from the cooling chamber and forming a fluidized bed of metal particles in the upper duct.

As it is apparent, the invention is based on the recourse to the technology of fluidized beds for efficiently cooling the powder in a cooling chamber adjacent to the atomizer chamber. In the case where an overflow is added at the lower section of the cooling chamber, the fluidized powder can be continuously discharged from the atomizer without disrupting the atomization process.

Other characteristics and advantages of the invention will be described in greater detail in the following description.

### BRIEF DESCRIPTION OF THE DRAWINGS

The invention will be better understood by reading the following description, which is provided purely for purposes of explanation and is in no way intended to be restrictive, with reference to:

FIG. 1, which illustrates a gas atomizer according to a variant of the invention,

FIG. 2 which illustrates possible regimes of fluidization,

FIG. 3, which illustrates a gas atomizer according to another variant of the invention,

FIG. 4 which illustrates an installation comprising two atomizers and a conveyor according to first variant of the invention,

FIG. 5 which illustrates an installation comprising two atomizers and a conveyor according to second variant of the invention,

FIG. 6, which illustrates a gas atomizer according to another variant of the invention,

FIG. 7, which illustrates a gas atomizer according to another variant of the invention.

### DETAILED DESCRIPTION

It should be noted that the terms “upper”, “lower”, “below”, “above”, “top”, “bottom”, “upstream”, “downstream”, . . . as used in this application refer to the positions and orientations of the different constituent elements of the device when the latter is installed in a plant.

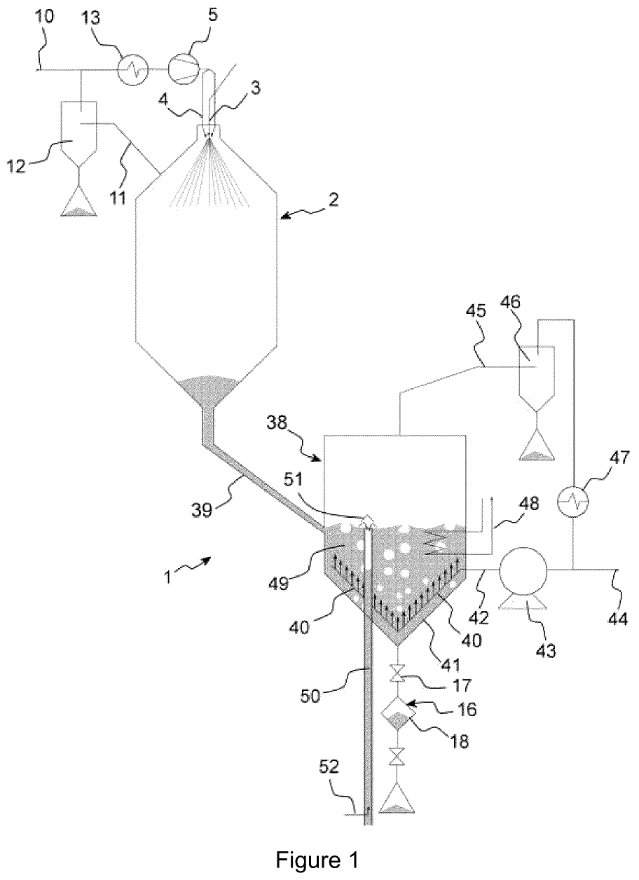

With reference to FIG. 1, a gas atomizer 1 is a device designed for atomizing a stream of liquid metal into fine metal droplets by impinging the stream with a high velocity gas stream. The gas atomizer 1 is mainly composed of a closed atomization chamber 2 maintained under protective atmosphere. The chamber has an upper section, a lower section, a top and a bottom.

The upper section of the chamber comprises an orifice, the nozzle 3, usually positioned at the center of the chamber top, through which the molten metal stream is forced. The nozzle is surrounded by a gas sprayer 4 for jetting a gas at high speed on the stream of liquid metal. The gas sprayer is preferably an annular slot through which pressurized gas flows. The gas sprayer is preferably coupled to a gas regulator 5 to control the flow and/or the pressure of the gas before jetting it. The gas regulator can be a compressor, a fan, a pump, a pipe section reduction or any suitable equipment.

The gas atomizer 1 preferably comprises a gas extractor 11 to compensate for the gas injection through the gas sprayer 4. The gas extractor is preferably located in the upper section of the atomization chamber. The gas extractor can be in the form of one pipe or a plurality of pipes connected on one side to the atomization chamber and on the other side to dedusting means 12. The dedusting means remove the finest particles from the extracted gas. They can comprise an electro-filter, a bag filter, a porous metal filter or a cyclone separator. Cyclone separator is preferred because it has relatively low pressure drops and it has no moving parts.

Preferably the gas extractor 11 is designed so that the gas injected in the chamber and extracted through the gas extractor can be recirculated. Consequently, the gas consumption is minimized. Accordingly, the gas extractor is preferably connected to the gas sprayer 4. In particular, the dedusting means 12, connected on one side to the atomization chamber, are connected on the other side to the gas regulator 5 coupled to the gas sprayer 4.

The connection between the gas extractor 11 and the gas sprayer 4 preferably comprises a heat exchanger 13. Consequently, the gas can be cooled to the temperature at which it has to be jetted on the molten metal stream in case the heat losses in the connection are not enough to bring the gas back to the desired temperature and/or if heat recovery is desired.

The connection between the gas extractor 11 and the gas sprayer 4 may also comprise a gas inlet 10 in case some fresh gas has to be introduced in the system, notably to compensate gas losses.

The lower section of the chamber is mainly a receptacle for collecting the metal particles falling from the upper section of the chamber. It is usually designed to facilitate the powder collection and powder discharge through a discharge opening positioned at the bottom of the chamber. It is thus usually in the form of an inverted cone or an inverted frustoconical shape.

The lower section of the chamber is connected to at least one cooling chamber 38. This cooling chamber has an upper section, a lower section, a top and a bottom. The connection preferably connects the bottom of the atomization chamber to the lower section of the cooling chamber. The connection can be in the form of a pipe 39 connecting the discharge opening of the atomization chamber to the cooling chamber. The pipe is preferably connected to the lower section of the cooling chamber, as illustrated on FIG. 1, to minimize the backflow of gas in the atomization chamber. The pipe can comprise a valve, either mechanical valve or pneumatic valve, to control the flow of metal particles.

The cooling chamber comprises gas injectors 40, positioned at the bottom of the chamber, capable of fluidizing the metal particles to be accumulated in the lower section of the chamber and capable of creating a bubbling fluidized bed of metal particles. Thanks to this fluidized bed, the metal particles transferred from the atomization chamber to the cooling chamber are efficiently cooled down below their oxidation window by intense gas-to-particle heat transfer. The metal particles accumulating in the lower section of the cooling chamber are kept cool and the hot particles discharged from the atomization chamber are very rapidly mixed in the fluidized bed and cooled. Furthermore, as the cooling can be done in a protective atmosphere, the metal particles do not oxidize during their cooling.

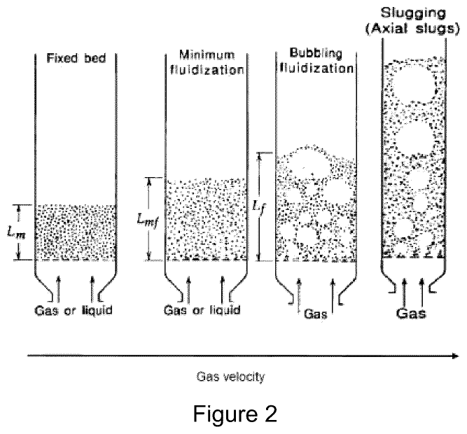

As illustrated in FIG. 2, there are several regimes of fluidization. Fluidization is the operation by which solid particles are transformed into a fluidlike state through suspension in a gas or a liquid. Depending on the fluid velocity, behavior of the particles is different. In gas-solid systems as the one of the invention, as the flow velocity increases, the bed of particles goes from a fixed bed to minimum fluidization, to bubbling fluidization and to slugging where agitation becomes more violent and the movement of solids become more vigorous. In particular, with an increase in flow velocity beyond minimum fluidization, instabilities with bubbling and channeling of gases are observed. At this stage, the fluidized bed is in a bubbling regime, which is the required regime for the invention in order to have a good circulation of the solid particles within the bed, a rapid cooling and a homogeneous temperature of the fluidized bed. Gas velocity to be applied to get a given regime and the desired temperature of the fluidized bed depends on several parameters like the kind of gas used, the size and density of the particles, the gas pressure drop offered by the gas injectors or the size of the chamber. This can be easily managed by a person skilled in the art. In addition, in the bubbling regime, the bed does not expand much beyond the solid volume which helps keeping installations at reasonable sizes. The concept of bubbling fluidized bed is defined in “Fluidization Engineering” by Daizo Kunii and Octave Levenspiel, second edition, 1991, notably in pages 1 and 2 of the Introduction.

Thanks to the bubbling fluidized bed, and contrary to other regimes of fluidized beds, the metal particles are very rapidly and very efficiently cooled down to the working temperature of the fluidized bed while maintaining a homogeneous distribution of the particle sizes within the bed. Consequently, there is no need to use powdery coolants to help the metal particles to cool.

In the context of the invention, “positioned at the bottom of the chamber” means that the gas injectors 40 are positioned sufficiently close to the bottom 41 of the chamber, in the lower section of the chamber, so that substantially all the particles transferred from the atomization chamber to the cooling chamber are fluidized. Solidified splashes resulting from the initial non-atomized metal stream and/or coarse particles may not be fluidized and may drop below the gas injectors, i.e. below the fluidized bed. The distance between the bottom of the cooling chamber and the gas injectors is preferably shorter than 10 cm, more preferably shorter than 4 cm, even more preferably between 1 and 3 cm.

The gas injectors 40 inject gas from the bottom of the cooling chamber toward the top of the chamber so that the particles at the bottom of the cooling chamber are lifted up and the fluidized bed is formed.

The gas injectors can comprise openings in the bottom wall of the chamber. Gas can be injected through these openings to fluidize the powder bed.

The gas injectors can comprise pipes 42 passing through the side wall of the chamber. The portion of the gas injectors positioned inside the chamber can follow the shape of the bottom wall at a close distance, as shown in the example illustrated in FIG. 1.

The gas injectors can comprise porous metal plates, sintered metal plates or canvas. The gas injectors preferably comprise spargers, which are parts, such as pipes, pierced with many small holes to provide dispersion of the injected gas. Spargers are preferred for gas velocities above 10 cm/s as they offer a sufficient pressure loss. The spargers are more preferably porous spargers. This type of spargers ensures the distribution of gas in the bed of metal particles by thousands of tiny pores.

Each sparger can comprise a grommet seal (compression fitting) which allows the sparger to be inserted and removed from the atomizer while the atomizer is in operation.

The gas injectors are coupled to a flow regulator 43. The latter controls the flow of gas injected through the gas injectors and thus the velocity of the gas in the cooling chamber since the section of the chamber is known. The gas flow can thus be adjusted so that the metal particles are fluidized and the obtained fluidized bed is maintained in a bubbling regime. The gas regulator can be in the form of a fan.

The fan speed is adjusted to control the flow of gas injected through the gas injectors. The flow regulator is connected to a gas source. The gas source can be a gas inlet 44 designed to let fresh gas in and/or a gas extractor providing recirculated gas as described below.

The cooling chamber 38 preferably comprises a gas extractor 45 to compensate for the gas injection through the gas injectors 40 and the possible gas coming from the atomization chamber 2. The gas extractor is preferably located in the upper section of the chamber so that it doesn't interfere with the fluidized bed and/or so that particles above the fluidized bed because of bubble splashing fall back in the bed by gravity before reaching high gas velocity regions which would suck them in the gas extractor. The gas extractor can be in the form of one pipe or a plurality of pipes connected on one side to the chamber and on the other side to dedusting means 46. The latter has the same optional features as the dedusting means 12 of the atomization chamber, as detailed earlier.

Preferably the gas extractor 45 is designed so that the gas injected in the cooling chamber and extracted through the gas extractor can be recirculated. Consequently, the gas consumption is minimized. Accordingly, the gas extractor is preferably connected to the gas injectors 40. In particular, the dedusting means 46 connected on one side to the cooling chamber are connected on the other side to the flow regulator 43 coupled to the gas injectors 40.

The connection between the gas extractor 45 and the gas injectors 40 preferably comprises a heat exchanger 47. Consequently, the gas can be cooled to the temperature at which it has to be injected in the chamber in case the heat losses in the connection are not enough to bring the gas back to the desired temperature and/or if heat recovery is desired.

The connection between the gas extractor 45 and the gas injectors 40 may also comprise a gas inlet 44 in case some fresh gas has to be introduced in the system, notably to compensate gas losses or to increase purity.

According to one variant of the invention, the gas atomizer further comprises a heat exchanger 48 positioned in the lower section of the chamber. It is positioned so that the bubbling fluidized bed 49 formed in the cooling chamber is in contact with the heat exchanger. The heat exchanger can be positioned at least partially within the cooling chamber or it can be a cooling jacket around the lower section of the cooling chamber. The solid particles kept in motion by the injection of gas through the gas injectors 40 come in contact with the heat exchanger where they release their heat to the transfer medium circulating within. The flow rate of medium inside the heat exchanger can be regulated to control the cooling rate. Such a heat exchanger facilitates the cooling of the particles in the fluidized bed and their holding at the desired temperature. The heat exchanger can also decrease the flow of gas needed to cool or maintain the particles at the desired temperature.

According to one variant of the invention, the gas atomizer 1 further comprises a coarse particle collector 16 below the bottom of the cooling chamber. As indicated above, solidified splashes resulting from the initial non-atomized metal stream and/or coarse particles may not be fluidized and may drop below the gas injectors, i.e. below the fluidized bed, at the bottom of the chamber. The coarse particle collector allows for the discharge of these undesired particles from the atomizer without disrupting the atomization. The coarse particle collector preferably comprises a valve 17 and a collection chamber 18. The collection chamber can be connected to a movable chamber through a second valve. This way the movable chamber can be replaced without compromising the pressure in the chamber.

According to one variant of the invention, once the metal particles have been produced and cooled by the fluidized bed, they are discharged through a discharge opening positioned at the bottom of the cooling chamber. It can be done once a batch of molten metal has been cooled or without disrupting the cooling depending on the technology of the discharge opening.

According to another variant of the invention, the gas atomizer comprises an overflow 50 in the lower section of the cooling chamber 38. Its purpose is to discharge the powder from the cooling chamber. In particular, the fluidized powder in the lower section of the cooling chamber can be discharged from the gas atomizer in a continuous mode as soon as the level of the fluidized bed reaches the top of the overflow 50. The atomizer can thus be run continuously.

The overflow 50 preferably extends at least partially in the lower section of the cooling chamber and passes through the bottom wall 41 of the chamber. It can be in the form of a downcomer. It is more preferably a pipe. Its section is preferably adapted to the powder flow to be discharged from the chamber. In particular, its section is adapted to the flow of metal particles entering the cooling chamber so that there is no accumulation of powder in the lower section of the chamber over time. In the case where the coarser particles formed in the atomizer would be collected at the bottom of the cooling chamber, the section of the overflow is preferably adapted to the flow of metal particles entering the cooling chamber, coarser particles set aside. The section of the pipe is preferably constant, i.e. without reductions along the pipe or at its upper extremity, to favor a homogeneous discharge of the metal powder and avoid clogging. In one variant of the invention, the overflow, or the pipe if applicable, comprises a valve for adjusting the powder flow to be discharged from the chamber. In one variant of the invention, the lower extremity of the overflow has a reduced section to further limit the flow of gas from the outside of the atomizer to the inside.

The height of the overflow is defined as the vertical distance between the top of the overflow and the bottom of the chamber, i.e. as the vertical length of the portion of the overflow extending in the chamber. The height of the overflow is preferably set so that the volume of fluidized bed is large enough to cool the metal powder at the desired temperature. The volume of the fluidized bed is indeed defined substantially by the section of the lower section of the chamber and the height of the overflow. If the overflow height is short, the volume of fluidized bed is low and the residence time of the particles in the fluidized bed is short. Consequently, the discharged particles are still hot. If the overflow height is very long, the volume of fluidized bed is high and the residence time of the particles in the fluidized bed is long. Consequently, the discharged particles are cold. Based on these principles, the person skilled in the art can select the height of the overflow depending on the dimensions of the chamber and the desired temperature of the discharged particles. In one variant of the invention, the overflow, or the pipe if applicable, comprises height adjustment means so that the height of the overflow can be adjusted on the fly, notably to adjust the cooling of the powder and consequently the temperature of the powder discharged from the chamber or to empty the chamber.

Thanks to the overflow, the residence time of the particles in the fluidized bed is homogeneous whatever the size of the particles, contrary to other solutions, like valves or pipes at the bottom of the chamber, for which coarser particles would be discharged first and before having been cooled to the desired temperature. Moreover, as the quantity of gas exiting the chamber through the overflow is low, the major part of the injected gas is used to fluidize the bed, which contributes to a very stable fluidized bed. In addition, the overflow is not a mechanical part which limits its wear by the particles.

According to one variant of the invention, the overflow 50 is overhung by a hat 51. Consequently, hot metal powder falling from the upper section of the chamber is prevented from directly entering the overflow. The hat is positioned high enough above the top of the overflow so that it doesn't disturb the powder flow discharged through the overflow.

According to one variant of the invention, the overflow 50, and preferably the portion of the overflow outside the chamber, further comprises a gas inlet 52. Consequently, gas, and preferably the one used for fluidizing the powder inside the cooling chamber, can be injected in the overflow. This helps to keep the discharge powder in a fluidized form and prevents the atmosphere downstream of the overflow from entering the chamber.

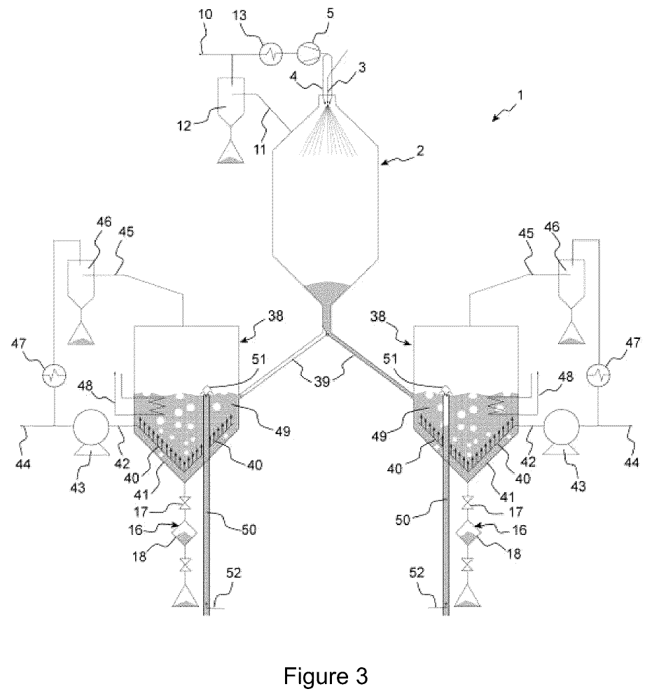

According to one variant illustrated on FIG. 3, the atomizer comprises a plurality of cooling chambers 38 connected to the atomization chamber 2, preferably to the bottom of the atomization chamber. Thanks to a redirecting valve positioned at the bottom of the atomization chamber, metal particles formed in the atomization chamber can be transferred to one cooling chamber and to another. It is an easy way to sort out different metal compositions produced in a row with an atomizer running continuously.

According to another variant, the cooling chamber comprises a multistage fluidized bed. In that case, at least one horizontal porous floor, divides the inside of the cooling chamber in different sections. The latter are connected to one another with overflows similar to overflow 50 described earlier. The gas injected through gas injectors 40 first fluidizes the metal particles laying in the bottom of the cooling chamber and then goes through the porous floor and fluidizes the metal particles laying on the porous floor, and so on. In other words, the metal particles discharged from the atomization chamber fall on a porous floor and undergo a first cooling step in a first stage of the fluidized bed. They are then discharged through the overflow to the lower level where they undergo a second cooling step in a second stage of the fluidized bed, and so on until they are cooled and discharged from the cooling chamber through the overflow 50. The porous floor can be made of a porous material or can be a perforated plate or any system preventing the particles from falling to the lower section. Such multistage fluidized bed improves the energy efficiency of the cooling step.

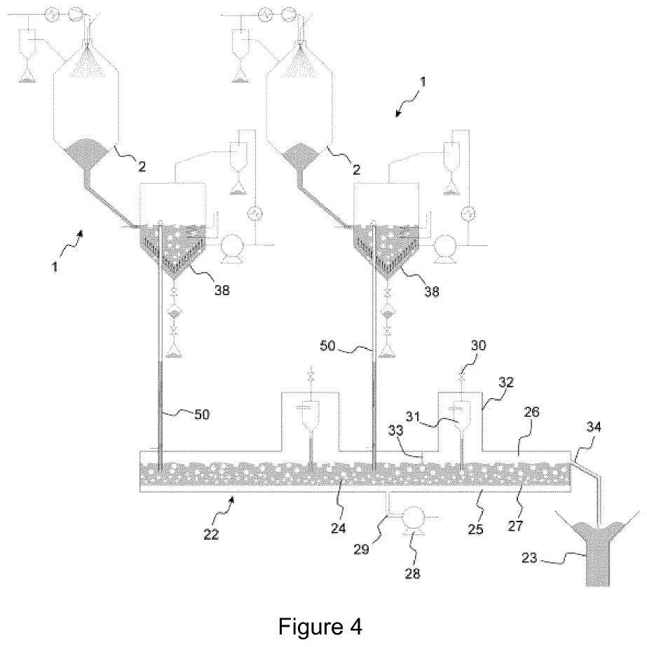

The powder discharged from the cooling chamber through the overflow can be collected in a chamber, a container or by a conveyor 22 (see. e.g., FIG. 4). The conveyor is part of the installation comprising the gas atomizer 1. Preferably, it transports the powder to a sieving station 23 and/or to a bagging station. The conveyor can notably be a vacuum pneumatic conveyor, a pressure conveyor or a suction-pressure conveyor.

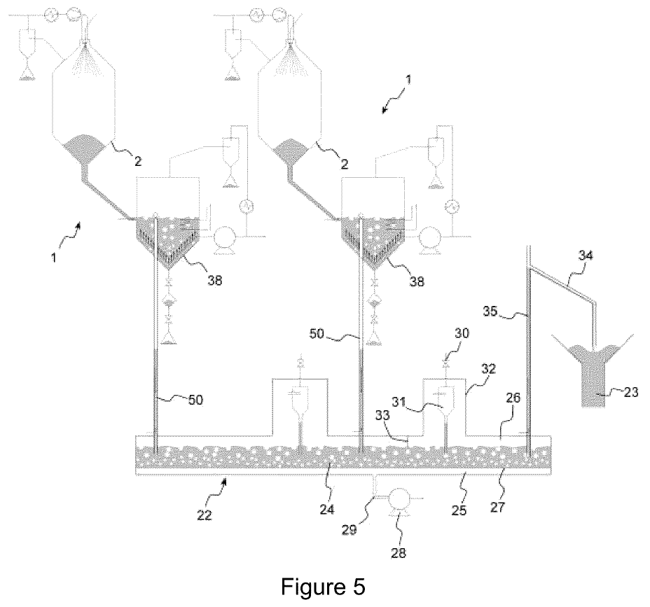

According to one variant of the invention illustrated on FIGS. 4 and 5, the powder discharged from the cooling chamber 38 is transported in the form of a fluidized bed 24, preferably a bubbling fluidized bed. This kind of transport is advantageous since it requires minimum ventilation power, dust emissions can be prevented and continuous operation can be ensured.

The conveyor 22 preferably comprises a lower duct 25 for the circulation of a fluidization gas, an upper duct 26 for the circulation of the powder and a porous wall 27 separating the lower and upper ducts over substantially their entire length.

The porous wall lets the fluidization gas go through it. Such porous wall is designed so that there is a sufficient pressure drop of the gas as it passes through the porous wall to ensure the homogeneous distribution of the gas over the entire cross-section of the upper duct. The porous wall can be a multi-ply canvas fabric or a porous refractory.

The lower duct is supplied with fluidization gas by means of a fluidization gas inlet 29 coupled to a flow regulator 28. The fluidization gas inlet can be in the form of a fluidization gas inlet conduit and the flow regulator can be in the form of a fan. The flow regulator controls the flow of gas injected in the lower duct and thus the velocity of the gas in the upper duct since the surface of the porous wall is known. The gas flow can thus be adjusted so that the metal particles in the upper duct are fluidized. When the flow regulator is a fan, its speed is adjusted to control the flow of fluidization gas injected in the lower duct. The flow regulator is connected to a gas source. The gas source can be a gas inlet designed to let fresh gas in and/or a conduit providing recirculated gas.

Thanks to this homogeneous distribution of the gas over the entire cross-section of the upper duct, only one flow regulator 28 can be used for the whole conveyor. This simplifies the installation and the maintenance.

The conveyor 22 comprises, at the top of the upper duct 26, at least one pressure valve 30 so that the pressure in fluidization gas in the upper duct can be regulated. The pressure valve is preferably connected to the upper duct through a filter, such as a cyclone 31 positioned in cyclone box 32. That way, the fluidization gas exiting the upper duct through the pressure valve is filtrated, i.e. the particles of the bed dragged by the flow of fluidization gas are separated from the gas and fall back in the fluidized bed. The cyclone box is preferably positioned above the level of the upper duct top to minimize the dragging of the particles in the cyclone.

Preferably, the conveyor 22 comprises a plurality of pressure valves 30 distributed along the length of the upper duct. This limits the horizontal circulation of the fluidization gas above the fluidized bed and thus further stabilizes the fluidized bed. More preferably, the plurality of pressure valves is combined with gas dams 33. Each dam is positioned transversally in the upper portion of the upper duct and in-between two consecutive pressure valves 30. These gas dams further limit the horizontal circulation of the fluidization gas above the fluidized bed.

The conveyor 22 comprises, at one of its extremity, a conveyor overflow 34 for discharging the powder in the sieving station 23 and/or in the bagging station. The conveyor overflow can be provided in the end section of the upper duct as illustrated on FIG. 4. In that case, as soon as the level of the fluidized bed reaches the level of the conveyor overflow, the powder flows in the sieving station and/or in the bagging station. The conveyor overflow can also be positioned above the extremity of the conveyor as illustrated on FIG. 5. In that case, it is connected to the upper duct through an upward pipe 35. The way the powder is discharged from the conveyor in that case is described later on. This configuration is very convenient to feed a sieving station and/or a bagging station which may not be fully positioned below the conveyor.

The conveyor 22 is connected, preferably at its other extremity, to the overflow 50 of the cooling chamber. In particular, the overflow lower end is connected to the upper duct 26. The conveyor can be connected to a plurality of overflows and thus to a plurality of atomizers. In that case, the overflows are distributed along the entire length of the conveyor. In case there is a plurality of pressure valves, they are preferably positioned in-between the overflows and the potential gas dam are preferably positioned adjacent to and upstream of an overflow.

The conveyor 22 is preferably a closed device communicating with the outside only by the overflow of the cooling chamber and the conveyor overflow as far as the powder is concerned, and only by the inlet conduit, preferably single, and the pressure valves as far as the fluidization gas is concerned.

The conveyor 22 is preferably horizontal. It can also be made of different portions. These portions can be at different levels. The transport can thus be easily adapted to the topography of the site.

To operate the conveyor 22, the fluidization gas is introduced at a given flow rate below the porous wall 27 which separates the lower duct 25 and the upper duct 26 of the conveyor.

The fluidization gas flows through the porous wall and then passes between the particles laying in the upper duct and forming the layer to be fluidized. As soon as the speed of fluidization gas in the interstitial space existing between the particles is sufficiently high, the particles are mobilized and then lifted, each particle losing its points of permanent contact with the neighboring particles. That way, a fluidized bed 24 is formed in the upper duct.

The powder discharged from the cooling chamber 38 through the overflow 50 in the upper duct 26 is kept in a fluidized form in the conveyor. As it behaves like a fluid, it remains level in the upper duct and a continuous flow of powder is created along the conveyor by discharging the fluidized bed at the conveyor overflow 34 from the conveyor to the sieving station and/or to the bagging station. In the case where the conveyor overflow is provided in the end section of the upper duct, the continuous flow is obtained as soon as the level of the fluidized bed reaches the level of the conveyor overflow. In the case where the conveyor overflow is connected to the upper duct by an upward pipe 35, the pressure in fluidization gas in the upper duct is set slightly above the atmospheric pressure so that the fluidized bed goes up in the upward pipe, up to the conveyor overflow. For example, in the case of steel particles, the over-pressure relatively to the atmospheric pressure can be set between 200 and 600 mbar per meter of upward pipe.

In case the supply in powder through the overflow 50 is discontinued, the level of the fluidized bed will decrease in the conveyor until it reaches the level of the conveyor overflow. At this point, the flow through the conveyor overflow stops. Inversely, if for some reason the conveyor overflow has to be temporarily closed, the level of the fluidized bed will increase in the conveyor. In that case, the supply in powder through the overflow of the cooling chamber may have to be discontinued only if the level of the fluidized bed reaches the top of the upper duct.

In addition, the powder transport with this conveyor can be turned on and off very easily. The inlet in fluidization gas has just to be turned on and off.

The fluidization gas can be air if the powder has been cooled enough and will not oxidize in contact with air. If there is a need to protect the powder from the atmosphere, the fluidization can be an inert gas, like argon or nitrogen. In that case, the inert gas is preferably recirculated.

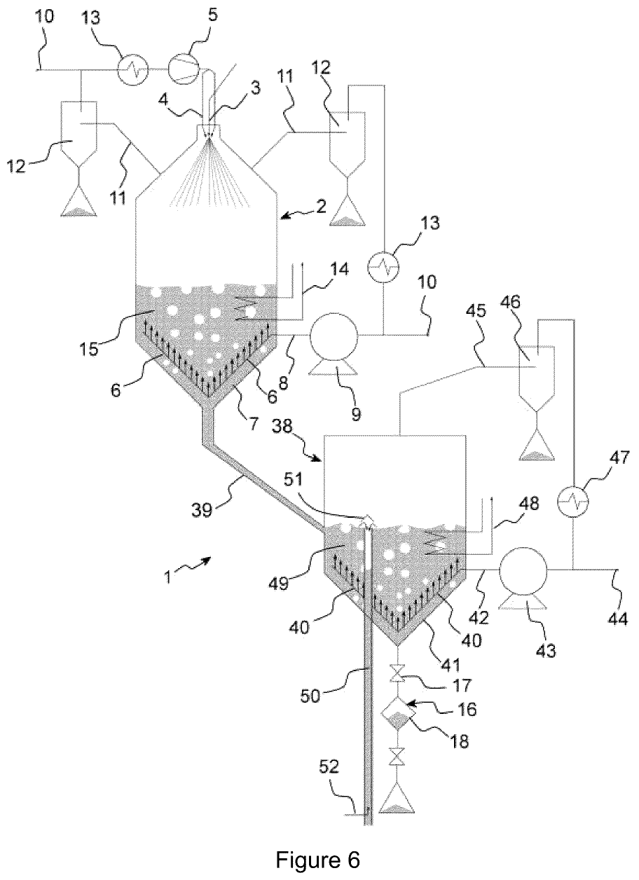

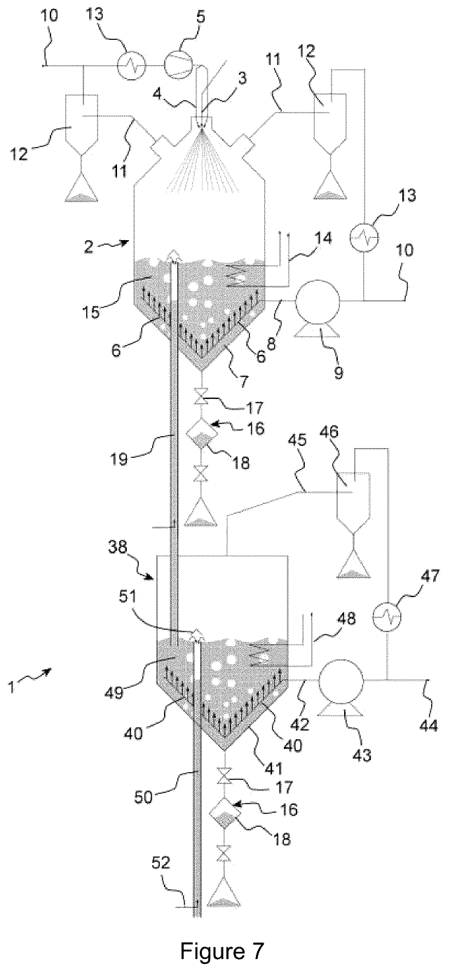

According to one variant of the invention illustrated on FIGS. 6 and 7, fluidized beds can be created in both the cooling chamber and the atomization chamber. Consequently, the metal particles can be cooled down in several steps, either with the same gas or with different gases.

In this variant, the gas atomizer further comprises gas injectors 6, positioned at the bottom of the atomization chamber, capable of fluidizing the metal particles to be accumulated in the lower section of the atomization chamber and capable of creating a bubbling fluidized bed of metal particles. Thanks to this fluidized bed, the metal particles efficiently undergo a first cooling step by intense gas-to-particle heat transfer. As a variant, a multistage fluidized bed as described earlier for the cooling chamber can be used.

Gas injectors 6 have the same optional features as the gas injectors 40 of the cooling chamber, as detailed earlier.

The gas injectors are coupled to a flow regulator 9. The latter controls the flow of gas injected through the gas injectors and thus the velocity of the gas in the atomization chamber since the section of the chamber is known. The gas flow can thus be adjusted so that the metal particles are fluidized and the obtained fluidized bed is maintained in a bubbling regime. The gas regulator can be in the form of a fan. The fan speed is adjusted to control the flow of gas injected through the gas injectors. The flow regulator is connected to a gas source. The gas source can be a gas inlet 10 designed to let fresh gas in and/or a gas extractor providing recirculated gas as described below.

The gas atomizer 1 preferably comprises a gas extractor 11 to compensate for the gas injection through the gas injectors 6, possibly in addition to the gas extractor 11 connected to the gas sprayer 4, as described earlier. The gas extractor is preferably located in the upper section of the atomization chamber for similar reasons as described above for the gas extractor 45 of the cooling chamber. The gas extractor can be in the form of one pipe or a plurality of pipes connected on one side to the chamber and on the other side to dedusting means 12. The latter have the same optional features as the dedusting means 46 of the cooling chamber, as detailed earlier.

Preferably the gas extractor 11 is designed so that the gas injected in the chamber and extracted through the gas extractor can be recirculated. Consequently, the gas consumption is minimized. Accordingly, the gas extractor is preferably connected to the gas injectors 6. In particular, the dedusting means 12 connected on one side to the chamber are connected on the other side to the flow regulator 9 coupled to the gas injectors 6.

On the example illustrated on FIG. 6, one dedusting means 12, in the form of a cyclone separator, is connected to the gas regulator 5 for jetting the gas on the metal stream so that the gas injected in the chamber to atomize the metal is recirculated. Another dedusting means 12, in the form of a cyclone separator, is connected to the flow regulator 9 for injecting gas at the bottom of the chamber so that the gas used for fluidizing the powder bed is recirculated. In both cases, filters can be added to clean the gas to be recirculated. Other designs of the gas recirculation are of course possible.

The connection between the gas extractor 11 and the gas injectors 6 preferably comprises a heat exchanger 13. Consequently, the gas can be cooled to the temperature at which it has to be injected in the chamber in case the heat losses in the connection are not enough to bring the gas back to the desired temperature and/or if heat recovery is desired.

The connection between the gas extractor 11 and the gas injectors 6 may also comprise a gas inlet 10 in case some fresh gas has to be introduced in the system, notably to compensate gas losses.

The gas atomizer may further comprise a heat exchanger 14 positioned in the lower section of the atomization chamber. This heat exchanger has the same optional features as the heat exchanger 47 of the cooling chamber, as detailed earlier.

In this variant of the invention, the atomization chamber 2 can be connected to the cooling chamber 38 with a pipe 39 comprising at its lower end a valve, such as for example a L-valve, a H-valve or a rotary valve to prevent the gas present in the cooling chamber from escaping through the pipe. Alternatively, the atomization chamber 2 can be connected to the cooling chamber 38 by an overflow 19 (as represented on FIG. 7) similar to the overflow 50 of the cooling chamber, as detailed earlier.

From a process perspective, the cooling of powder inside the cooling chamber 38 is made possible thanks to a process for manufacturing metal powders comprising:
(i) feeding an atomization chamber 2 of a gas atomizer 1 with molten metal,
(ii) atomizing the molten metal by injection of gas so as to form metal particles,
(iii) transferring the metal particles from the atomization chamber to a cooling chamber 38
(iv) cooling the metal particles in the cooling chamber by injecting gas from the bottom of the cooling chamber so as to form a bubbling fluidized bed 49 of metal particles.

Preferably, this process is for continuously manufacturing metal powders, as it will be described in greater details below.

The metal to be atomized can be notably steel, aluminum, copper, nickel, zinc, iron, alloys. Steel includes notably carbon steels, alloyed steels and stainless steels.

The metal can be provided to the atomizer in solid state and melted in a tundish connected to the atomizer through the nozzle. It can also be melted at a previous step and poured in the tundish.

According to one variant of the invention, the molten metal to be atomized is steel obtained through a blast furnace route. In that case, pig iron is tapped from a blast furnace and transported to a converter (or BOF for Basic Oxygen Furnace), optionally after having been sent to a hot metal desulfurization station. The molten iron is refined in the converter to form molten steel. The molten steel from the converter is then tapped from the converter to a recuperation ladle and preferably transferred to a ladle metallurgy furnace (LMF). The molten steel can thus be refined in the LMF notably through de-oxidation and a primary alloying of the molten steel can be done by adding ferroalloys or silicide alloys or nitride alloys or pure metals or a mixture thereof. In certain cases where demanding powder compositions have to be produced, the molten steel can be also treated in a vacuum tank degasser (VTD), in a vacuum oxygen decarburization (VOD) vessel or in a vacuum arc degasser (VAD). These equipment allow for further limiting notably the hydrogen, nitrogen, sulphur and/or carbon contents.

The refined molten steel is then poured in a plurality of induction furnaces. Each induction furnace can be operated independently of the other induction furnaces. It can notably be shut down for maintenance or repair while the other induction furnaces are still running. It can also be fed with ferroalloys, scrap, Direct Reduced Iron (DRI), silicide alloys, nitride alloys or pure elements in quantities which differ from one induction furnace to the others.

The number of induction furnaces is adapted to the flow of molten steel coming from the converter or refined molten steel coming from the ladle metallurgy furnace and/or to the desired flow of steel powder at the bottom of the atomizers.

In each induction furnace, alloying of the molten steel is done by adding ferroalloys or silicide alloys or nitride alloys or pure metals or a mixture thereof to adjust the steel composition to the composition of the desired steel powder.

Then, for each induction furnace, the molten steel at the desired composition is poured in a dedicated reservoir connected to at least one gas atomizer. By “dedicated” it is meant that the reservoir is paired with a given induction furnace. That said, a plurality of reservoirs can be dedicated to one given induction furnace. For the sake of clarity, each induction furnace has its own production stream with at least one reservoir connected to at least one gas atomizer. With such parallel and independent production streams, the process for producing the steel powders is versatile and can be easily made continuous.

The reservoir is mainly a storage tank capable of being atmospherically controlled, capable of heating the molten steel and capable of being pressurized.

The atmosphere in each of the dedicated reservoirs is preferably Argon, Nitrogen or a mixture thereof to avoid the oxidation of the molten steel.

The steel composition poured in each reservoir is heated above its liquidus temperature and maintain at this temperature Thanks to this overheating, the clogging of the atomizer nozzle 3 is prevented. Also, the decrease in viscosity of the melted composition helps obtaining a powder with a high sphericity without satellites, with a proper particle size distribution.

Finally, when a dedicated reservoir is pressurized, the molten steel can flow from the reservoir to at least one of the gas atomizers connected to the reservoir.

According to another variant of the invention, the metal to be atomized is steel obtained through an electric arc furnace route. In that case, raw materials such as scraps, metal minerals and/or metal powders are fed into an electric arc furnace (EAF) and melted into heated liquid metal at a controlled temperature with impurities and inclusions removed as a separate liquid slag layer. The heated liquid metal is removed from the EAF into a ladle, preferably into a passively heatable ladle and moved to a refining station where it is preferably placed in an inductively heated refining holding vessel. There, a refining step, such as a vacuum oxygen decarburization is performed to remove carbon, hydrogen, oxygen, nitrogen and other undesirable impurities from the liquid metal. The ladle with the refined liquid metal can then be transferred above a closed chamber under controlled vacuum and inert atmosphere and containing the heated tundish of an atomizer. The ladle is connected to a feeding conduit and the heated tundish is then fed in refined liquid metal through the feeding conduit.

Alternatively, the ladle with the refined liquid metal is transferred from the refining station to another inductively heated atomizing holder vessel located at the door of an atomizer station containing a pouring area under controlled vacuum and inert atmosphere with the heated tundish of a gas atomizer. The inductively heated atomizing holder vessel is then introduced into a receiving area where the vacuum and atmosphere are adjusted to the one of the pouring area. Then, the vessel is introduced into the pouring area and the liquid metal is poured into the heated tundish at a controlled rate and atomized with the atomizer.

In both variants, the molten metal is maintained at the atomization temperature in the tundish until it is forced through the nozzle 3 in the chamber 2 under controlled atmosphere (step (i)) and impinged by jets of gas which atomize it into fine metal droplets (step (ii)).

For step (ii), the gas injected through the gas sprayer 4 to atomize the metal stream is preferably argon or nitrogen. They both increase the melt viscosity slower than other gases, e.g. helium, which promotes the formation of smaller particle sizes. They also control the purity of the chemistry, avoiding undesired impurities, and play a role in the good morphology of the powder. Finer particles can be obtained with argon than with nitrogen since the molar weight of nitrogen is 14.01 g/mole compared with 39.95 g/mole for argon. On the other hand, the specific heat capacity of nitrogen is 1.04 J/(g K) compared to 0.52 for argon. So, nitrogen increases the cooling rate of the particles.

The gas flow impacts the particle size distribution and the microstructure of the metal powder. In particular, the higher the flow, the higher the cooling rate. Consequently, the gas to metal ratio, defined as the ratio between the gas flow rate (in m3/h) and the metal flow rate (in Kg/h), is preferably kept between 1 and 5, more preferably between 1.5 and 3.

Once metal particles have been obtained from the atomization of molten metal in the atomization chamber, the obtained powder deposited at the bottom of the atomization chamber is transferred to the cooling chamber 38.

The metal particles are then cooled down in the cooling chamber by injecting gas from the bottom of the chamber so as to form a bubbling fluidized bed 49 of metal particles (step (iv)). This step is preferably done simultaneously with the atomization step. It is more preferably done continuously and simultaneously with the atomization step. This way the atomizer can work continuously.

During this step, the metal particles are preferably cooled down below their oxidation window. In the case of steel powder, the metal particles are preferably cooled below 300° C., more preferably below 260° C., even more preferably between 150 and 260° C. With such a cooling, the powder can then be manipulated in the air at the next steps of the process. Depending on the sensitivity of the steel composition to oxidation and/or the purity of the gas, the cooling can be adjusted. The powder is preferably not cooled too much, e.g. below 150° C., to limit the gas flow needed to cool the powder. In a continuous mode, the gas flow is adjusted so that the fluidized bed is maintained at a constant temperature while a part of the particles is continuously discharged from the chamber and new hot particles are continuously added to the bed. In that case, the fluidized bed is maintained below 300° C., more preferably below 260° C., even more preferably between 150 and 260° C.

According to one variant of the invention, the gas injected through the gas injectors 40 of the cooling chamber to fluidize the powder bed is preferably argon or nitrogen, and more preferably the same gas as the one used to atomize the molten metal stream in the atomization chamber. It is preferably injected at a velocity between 1 and 80 cm/s, more preferably between 1 and 20 cm/s, which requires a low ventilation power and so a reduced energy consumption. The gas flow is preferably regulated by the flow regulator 43 of the cooling chamber, such as a fan.

The gas is preferably injected at a temperature comprised between 10 and 50° C. This further improves the cooling of the metal particles.

According to another variant of the invention, the gas injected through the gas injectors 40 of the cooling chamber to fluidize the powder bed is a reducing gas for the metal particles. Consequently the metal particles can be simultaneously cooled down and treated to remove the possible oxide formed at the surface of the particles in the atomization chamber because of traces of oxygen in the inert gas used for atomization. For steel, an example of reducing gas is a mixture of nitrogen and hydrogen.

The gas injected in the cooling chamber is preferably extracted from the cooling chamber to maintain a constant pressure in the chamber. The gas flow in the gas extractor 45 is adjusted accordingly. The overpressure in the chamber 2 is preferably set between 5 and 100 mbars.

The gas injected in the cooling chamber is preferably recirculated. In that case, it is more preferably cooled down after being extracted from the chamber. It is preferably cooled down below 50° C., more preferably between 10 and 50° C.

During step (iv), the cooling of the metal particles can be further enhanced by contacting the fluidized bed with a heat exchanger 47.

The process according to the invention can further comprise a step (v) of continuously discharging cooled metal particles from the cooling chamber. This step is preferably done simultaneously with the atomization step and with the cooling step. The continuous discharge can be done through an overflow 50, as described earlier.

The process according to the invention can further comprise a step (vi) of transporting the discharged metal particles to a sieving station 23 and/or to a bagging station. This step is preferably done simultaneously with the atomization step, with the cooling step and with the discharging step.

The discharged metal particles can be transported in the form of a fluidized bed 24. It is preferably a bubbling fluidized bed.

The process according to the invention can further comprise an additional step between steps (ii) and (iii) during which the metal particles undergo a first cooling step in the atomization chamber by injecting gas from the bottom of the atomization chamber so as to form a bubbling fluidized bed (15) of metal particles, as described earlier. In that case, the metal particles can be first cooled to a first temperature with an inert gas in the atomization chamber and then further cooled to a second temperature with an inert gas or with a reducing gas in the cooling chamber. The first temperature can be comprised between 300° C. and 450° C. The second temperature can be comprised between 150° C. and 300° C.

1-19. (canceled)

20. A process for manufacturing metal powders, comprising:
(i) feeding an atomization chamber of a gas atomizer with molten metal;
(ii) atomizing the molten metal by injection of gas so as to form metal particles;
(iii) transferring the metal particles from the atomization chamber to a cooling chamber of the gas atomizer; and
(iv) cooling the metal particles in the cooling chamber by injecting gas from the bottom of the cooling chamber so as to form a bubbling fluidized bed of metal particles.

21. The process as recited in claim 20 wherein steps (ii), (iii) and (iv) are done simultaneously.

22. The process as recited in claim 20 wherein, in step (iv), the metal particles are cooled below 300° C.

23. The process as recited in claim 20 wherein, in step (iv), the injected gas is extracted, cooled down and re-injected.

24. The process as recited in claim 20 further comprising the step (v) of continuously discharging metal particles from the cooling chamber.

25. The process as recited in claim 24 further comprising the step (vi) of transporting the discharged metal particles to a sieving station.

26. The process as recited in claim 25 wherein the discharged metal particles are transported in the form of a fluidized bed.

27. The process as recited in claim 20 further comprising an additional step between steps (ii) and (iii) wherein the metal particles undergo a first cooling step in the atomization chamber by injecting gas from the bottom of the atomization chamber so as to form a bubbling fluidized bed of metal particles.

28. The process as recited in claim 27 wherein the cooling steps in the atomization chamber and in the cooling chamber are done with different gases.

29. A gas atomizer comprising:
an atomization chamber;
a cooling chamber connected to the bottom of the atomization chamber;
gas injectors positioned at the bottom of the cooling chamber; and
a flow regulator coupled to the gas injectors for fluidizing the metal particles to be accumulated in the cooling chamber and forming a bubbling fluidized bed of metal particles.

30. The gas atomizer as recited in claim 29 wherein a distance between the bottom of the cooling chamber and the gas injectors is shorter than 10 cm.

31. The gas atomizer as recited in claim 29 further comprising a heat exchanger positioned in the lower section of the cooling chamber.

32. The gas atomizer as recited in claim 29 further comprising an overflow in the lower section of the cooling chamber.

33. The gas atomizer as recited in claim 29 further comprising a gas extractor in the upper section of the cooling chamber.

34. The gas atomizer as recited in claim 33 wherein the gas extractor is connected to the gas injectors for gas recirculation within the atomizer via a connection.

35. The gas atomizer as recited in claim 34 wherein the connection between the gas extractor and the gas injectors includes a heat exchanger.

36. The gas atomizer as recited in claim 29 further comprising gas injectors positioned at the bottom of the atomization chamber and a flow regulator coupled to the gas injectors for fluidizing the metal particles to be accumulated in the lower section of the atomization chamber and forming a bubbling fluidized bed of metal particles.

37. An installation comprising:
a gas atomizer as recited in claim 29; and
a conveyor including a lower duct for the circulation of gas, an upper duct connected to the cooling chamber for the circulation of powder material and a porous wall separating the lower and upper ducts over substantially their entire length.

38. The installation as recited in claim 37 wherein the lower duct of the conveyor includes a fluidization gas inlet and a flow regulator coupled to the fluidization gas inlet for fluidizing the metal particles to be discharged from the cooling chamber and forming a fluidized bed of metal particles in the upper duct.
